(19) United States
(12) Patent Application Publication
(10) Pub. No.: US 2007/0221337 A1
(43) Pub. Date: Sep. 27, 2007

(54) Device for Clamping in Centered Position Parts to be Subjected to Machining and Machine Tool Comprising the Device

(76) Inventors: Roberto Sammartin, Selvazzano (IT); Bruno Velentini, Camposampiero (IT)

Correspondence Address: RATNERPRESTIA, P O BOX 980, VALLEY FORGE, PA, 19482-0980, US

(21) Appl. No.: 11/630,636

(22) PCT Filed: Dec. 6, 2004
(86) PCT No.: PCT/IT04/00678

§ 371 Date: Dec. 22, 2006

(30) Foreign Application Priority Data
Jul. 2, 2004 (IT) PD2004A000177

(51) Int. Cl. B60B 30/00

(52) U.S. Cl. 157/14

(57) ABSTRACT

A device is described for clamping parts in a centered position which are to be machined, including a device for centring the part on a worktable including at least three centering elements with a regular angular spacing. Each centering element is displaceable along a predetermined radial direction (Y), and there are actuating devices associated with each respective centering element for operational actuation thereof in the translational movement along the corresponding radial direction (Y). Each actuating device, for each centring element, includes a an actuating element capable of being driven in a rotational motion and a first motion transmission device capable of converting the rotational motion of the actuating element into translational motion of the corresponding centering element along the corresponding radial direction (Y), and a second motion transmission device between the actuating elements capable of synchronously transmitting the rotational motion of one of the actuating elements to the other actuating elements so as to impart a synchronized translational movement of the centering elements along the respective radial translation directions (Y).

This application is a U.S. National Phase Application of PCT International Application PCT/IT2004/000678 which is incorporated by reference herein.

### TECHNICAL FIELD

The present invention relates to a device for centering and clamping parts to be subjected to machining including a part centering device and actuating means. The invention also provides a machine tool comprising the device.

### BACKGROUND OF THE INVENTION

The invention concerns in particular, although not exclusively, the specific technical object of centering parts to be subjected to machining, for example turning or other surface finishing, with the aim of effecting centering of the part relative to the geometric axis of rotation of the equipment or worktables typically provided in conventional machining centers. Although the invention may be used in any machining center where it is necessary to center parts with substantially axially symmetrical geometry, it was devised with particular reference to the centering of semi-finished vehicle wheels made from light alloy, in particular from aluminium alloy, said term being intended to denote the overall structure comprising rim and wheel, which is generally obtained as a semi-finished casting and is subjected to subsequent turning and surface finishing.

There is a necessity in this connection to centre the semi-finished part, this operation conventionally being performed by means of a three-point centering device in which three centering elements, typically of the jaw type, arranged at 120° to one another, are displaced along radial guides relative to geometric axis of the device to clamp the part in centered position.

Typical known applications provide the use of centering devices in which the travel in the radial direction of each centering element is limited to a range of a few millimetres. The maximum extent of said radial travel is conventionally within the range of 5 to 7 millimetres.

When such devices are used in processing lines in which the parts supplied to the machining centers exhibit, in random sequences, different dimensions within relatively wide dimensional ranges (in the case of wheels, the nominal diameter of the semifinished products may vary, for example, between 13 and 24 inches), the maximum extent of travel of the centering elements does not allow the entire dimensional range to be encompassed.

Furthermore, since it is preferable for it to be possible to supply the parts to the machining centers substantially randomly, so resulting in sequences of semi-finished parts which differ in dimensions from one another, the variation in the dimensions of the part to be machined makes setup, which is conventionally almost always performed manually, time-consuming and costly.

### BRIEF DESCRIPTION OF THE INVENTION

The problem underlying the present invention is to provide a device for clamping in centered position semi-finished parts to be subjected to machining, which device is structurally and functionally designed to overcome the shortcomings stated with reference to the cited prior art.

This problem has been solved by the present invention. The present invention relates to a device for clamping in a centered position parts to be subjected to machining. The device includes a part centering device having at least three centering elements with a regular angular spacing which are capable of contacting the part and displacing it to a centered position. Each of the centering elements is displaceable along a predetermined radial direction (Y), and the radial directions (Y) intersect at a geometric part centering axis (X). Also provided are actuating means associated with each respective centering element for operational actuation thereof in the translational movement along the corresponding radial direction (Y). The actuating means comprise for each centering element, a respective actuating element capable of being driven in a rotational motion and respective first motion transmission means capable of converting the rotational motion of the actuating element into a translational motion of the corresponding centering element along the corresponding radial direction (Y), and second motion transmission means, between the actuating elements, capable of synchronously transmitting the rotational motion from one of the actuating elements to the other actuating elements, so as to permit synchronized translational movement of the centering elements along the respective radial translation directions (Y). The invention also includes a machine tool for machining parts including the above-described device.

### BRIEF DESCRIPTION OF THE DRAWINGS

The features and advantages of the invention will emerge more clearly from the following detailed description of preferred exemplary embodiments which are illustrated in indicative, non-limiting manner with reference to the attached drawings in which:

FIG. 1 is a partial schematic front elevational view of a first example of a device for clamping parts in centered position according to the present invention,

FIG. 2 is another overall schematic diagram of the device of FIG. 1,

FIG. 3 is a partial perspective view of the device of the preceding Figures,

FIG. 4 is a view corresponding to that of FIG. 1 of a second exemplary embodiment of the invention,

FIG. 5 is an overall partial axially sectional view of the example of the device of FIG. 4,

FIG. 6 is a perspective view of the device of FIGS. 4 and 5.

### DESCRIPTION OF THE INVENTION

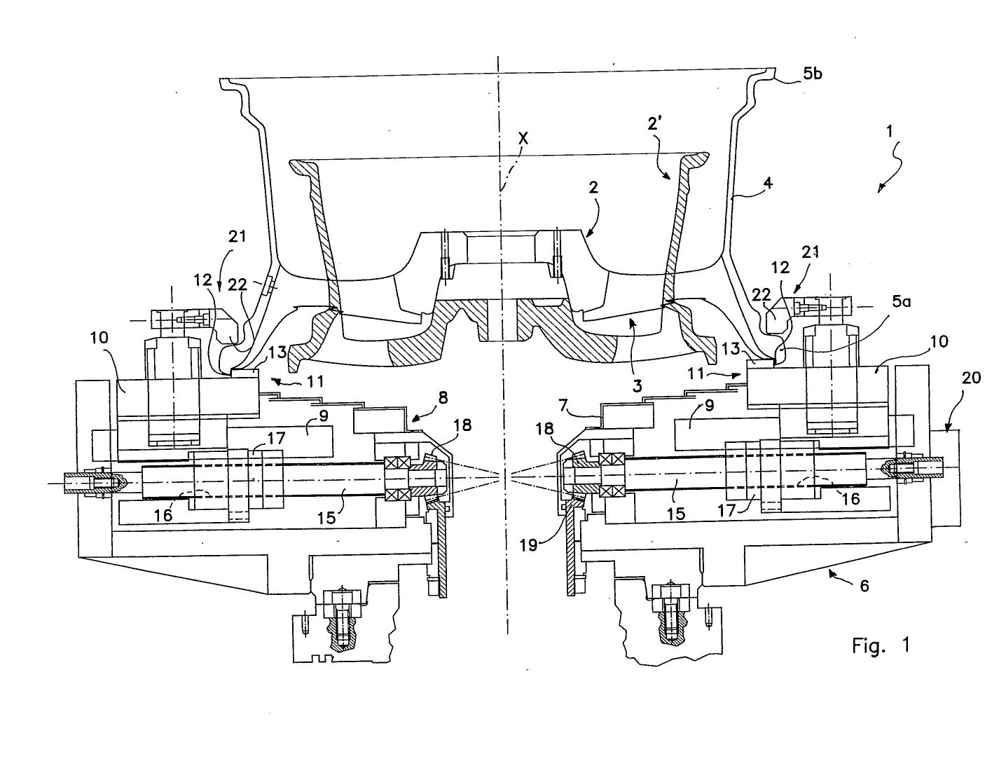

With initial reference to FIGS. 1 to 3, 1 denotes overall a first example of a device for centering and clamping (semi-finished or less than semi-finished) parts which are intended to be subjected to subsequent machining, said device being in accordance with the present invention. Said device is described below with particular reference to semi-finished vehicle wheels 2 made from light alloy, in particular from aluminium alloy, it nevertheless being understood that said application constitutes a preferred but non-limiting choice as the invention may equally effectively be applied in any case in which there is a requirement to centre and clamp parts of an axially symmetrical geometry (such as for example brake disks, flywheels, drums and others).

In the present context, the term “wheel” is intended to denote the overall rim and wheel structure for vehicles, typically provided with a perforated front portion 3 (comprising through-holes for attaching the rim to the vehicle's hub) from which there proceeds a wall 4 which extends almost cylindrically and comprises opposing circumferential edges 5a, 5b which project radially to define the contact surface of the wheel with the tyre.

The device 1 comprises a supporting frame 6 on which there is mounted a table 7 comprising a central through hole 8.

On the table 7, there are provided three guide elements 9 extending radially relative to the geometric central axis of the device, indicated X, and arranged at regular angular intervals (at 120° to one another). Alternatively, other configurations are possible with a different number of guide elements and a corresponding angular interval.

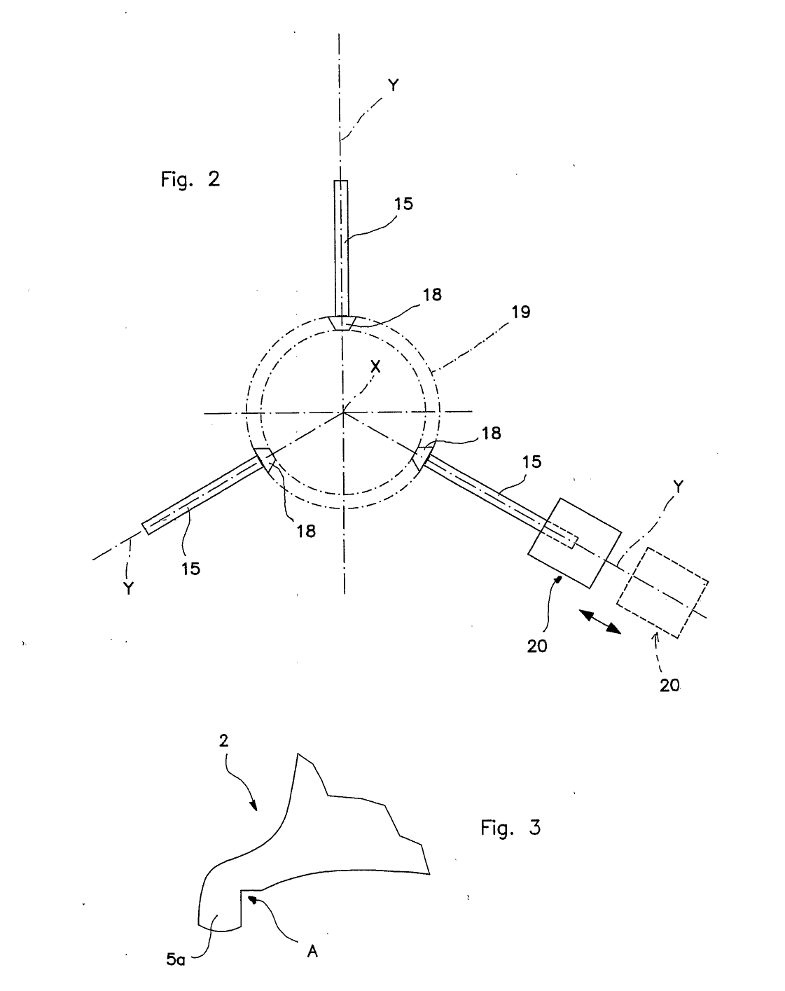

Each guide 9 is associated with a respective slide 10 of a corresponding centering element 11 such as to guide the latter along the respective radial direction (indicated Y in FIG. 2) in a translational movement away from and towards the axis X.

The centering elements 11 are each structurally identical and only one of them will be described in detail below.

The slide 10 comprises, at one end, a projection 12 having an extension such as to interact with the edge 5a of the wheel following the radial movement of the slide and thus capable of drawing the wheel away from the axis X. The projection 12 may conveniently be the end of a removable block 13 attached to the slide 10, so likewise defining the vertical position of the part.

Actuating means are provided to move each slide 10, said means including an actuating element which conveniently takes the form of a maneuvering rod 15 which extends axially and parallel to the radial direction Y of the corresponding centering element 11 and is supported rotatably on the table 7. The rod 15 is externally threaded along its axial portion and the corresponding screw mates with a respective internal thread 16 integral with the slide 10. More particularly, said screw is of the recirculating ball type and the corresponding associated mating internal thread is located in a lead nut structure 17 integral with the slide 10. As a result, the rotational movement of the manoeuvring rod 15 is converted into a translational movement of the lead nut 17, and integral therewith, of the slide 10, with the consequent displacement of the centering element 11 in the corresponding radial direction Y away from and towards the axis X.

The device 1 also comprises transmission means including in each manoeuvring rod a respective gear 18 keyed onto a free end of the rod. The three gears 18 are in meshing engagement with a toothed wheel 19, such that the rotational motion of one of said manoeuvring rods 15 is transmitted synchronously to the other manoeuvring rods. Per se conventional devices are also provided for recovering or eliminating play in the kinematic connections which are present.

Each gear 18 conveniently defines with the toothed wheel 19 a gear pair with orthogonal axes assuming the form of a bevel wheel and pinion.

A motor unit is designated 20 and shown only schematically in the drawings, which motor unit is provided with its own independent movement for meshing and is operationally associated with one of the manoeuvring rods 15 in order to transmit to the latter rotational motion around the axis thereof. Thanks to the mating between the pinions 18 and wheel 19, the rotational motion imparted by the motor unit 20 to one of the rods 15 is transmitted, in particular in synchronized manner, to the other manoeuvring rods, so ensuring synchronous movement of the three centering elements 11. It should be noted that the motor unit is attached to the machine, being mobile between preselected working positions (at least a second position is shown in dashed lines in FIG. 2).

Clamping means 21 for the part subjected to centering are also provided on each slide 10, said clamping means comprise a clamping foot 22 mounted in articulated manner on the slide in such a manner as to be displaceable towards an operating position in which it is pressed on the wheel 2 at the edge 5a in order to ensure clamping thereof.

It is also provided that each slide 10 may be clamped relative to its own guide by means of respective clamping means 23 comprising for example appropriately sized and supplied hydraulic or pneumatic cylinders.

Thanks to the presence of these latter clamping means, each centering element is reversibly clamped relative to the table 7 once the desired centering position has been reached (along the direction Y).

In operation, it is intended that the semi-finished wheel 2 be initially rested on table 7. In this phase, the centering elements 11 are moved back towards the axis X with identical radial positioning relative to said axis, but such that the projections 12 are located between the axis X and the peripheral edge 5a of the wheel.

In a subsequent phase, it is provided that the three centering elements 11 are moved in mutually synchronized manner along their respective radial directions Y away from the axis X by actuation of the motor unit 20 which is attached to the machine and is provided with its own meshing movement. The position is checked by a position sensor (for example an encoder) and by verification of the clamping torque. The motor is preferably of the controlled movement type, such that the rotation thereof and thus the translational travel of the respective slide 10 associated therewith may be controlled with accuracy and precision.

In particular, it is provided that the end of each centering element (block 13) acts on a previously machined surface of the wheel, indicated with A in the drawings and comprising for example three surface portions having cross-sections arranged at 120° relative to one another, as shown in FIG. 3.

Once the centered position of the wheel relative to the axis X has been reached, the movement of the centering elements 11 is stopped and the clamping means 21 are activated with displacement of each foot 22 onto the wheel 2. At the same time, each slide is clamped relative to its own guide on the table 7 by actuation of the clamping means 23.

Once the semi-finished wheel has been clamped in the centered position, 20 will stop and the machining phases planned for the corresponding processing cycles are initiated.

It should first of all be noted how, with the device of the invention, it is possible to effect centering of parts in a wide range of dimensions of parts and the consequent length of travel required of the centering elements. By way of example, FIG. 1 shows another semi-finished wheel 2′, differing from the wheel 2, of an appreciably smaller size than the wheel 2, but which may equally readily be clamped in a centered position by means of the device 1.

It should also be noted how the device according to the invention is of dimensions such that the semi-finished product is readily accessible, in particular with regard to the front portion 3 of the wheel, through the central hole 8 of the supporting frame 6. In this connection, it is provided that the toothed wheel 19 be centrally hollow (FIG. 1) in order to facilitate access to the part and the possible discharge of sprue (arising from preceding casting operations).

This ease of access makes it possible to perform subsequent phases in the machining of the part with particular speed and without requiring repositioning of the semi-finished product.

One principal advantage which is achieved is that the centering device according to the invention enables improved flexibility and versatility in part centering and clamping operations, in particular ensuring speed and accuracy in centering parts which are of different sizes and dimensions (for example semi-finished wheels of different diameters). This advantageously makes it possible to incorporate said device into machining centres which it is intended to supply with different types of parts for machining (in particular of different dimensions relative to one another) and in accordance with substantially random sequences. These features, which are demanded by the market, make it possible to respond in “real time” to market requirements.

Another advantage consists in the improved accessibility to the semi-finished part provided by the device of the invention together with a smaller overall size relative to known solutions.

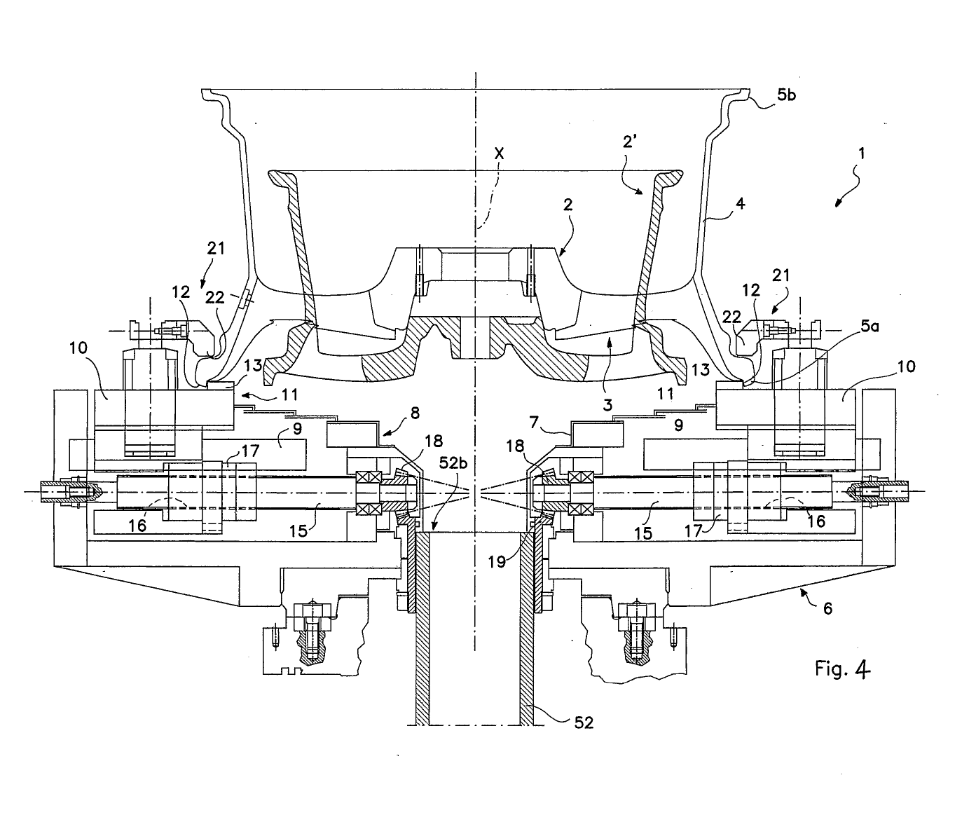

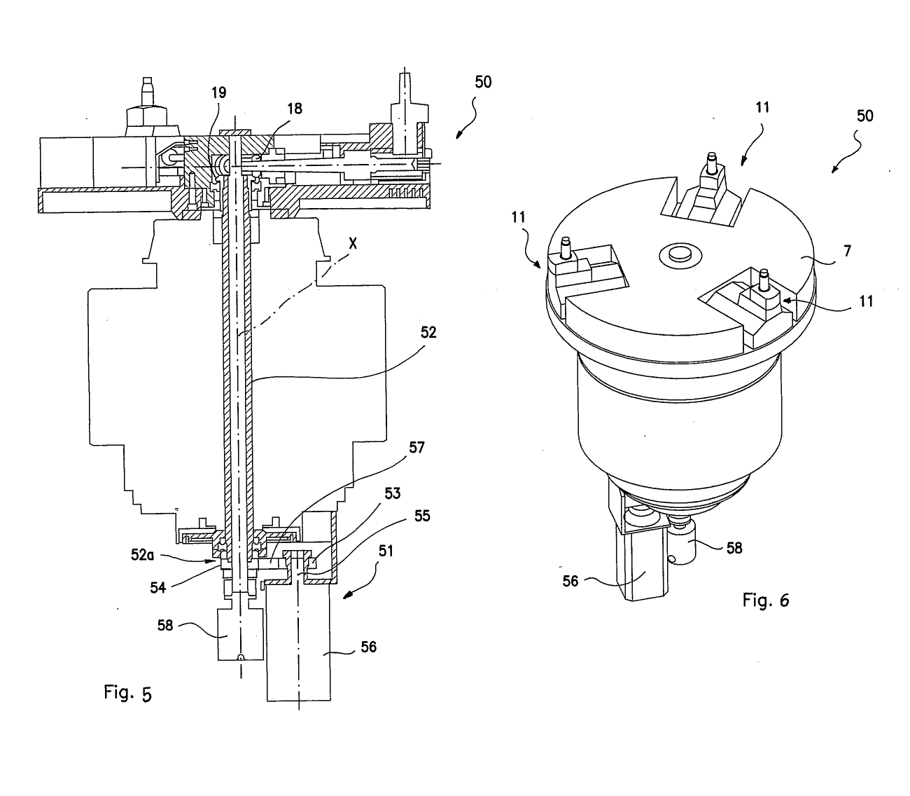

Another equally significant advantage resides in the fact that it is possible to achieve true centering of the part by using surfaces (A) thereof which have previously been machined. It is provided that such surfaces are machined at the same time as the wheel fastening holes, so enabling ideal geometry and consequently a lower level of imbalance of the part. With reference to FIGS. 4 to 6, 50 denotes overall a second example of a device for centering and clamping parts to be subjected to subsequent machining, produced in accordance with the present invention, in which details similar those of the preceding example are denoted by the same reference numerals.

The device 50 primarily differs from that described in the preceding example in that a motor unit, denoted overall 51, is provided which is not directly associated with any one of the centering elements, but is instead operationally associated with an axial end 52a of a transmission shaft 52, to the opposite end 52b of which is keyed the toothed wheel 19.

The shaft 52 extends, coaxially with the main axis X, from the opposite side of the table 7 relative to the operational zone for centering and clamping the part and is made with an axially hollow tubular structure. As a result, the motor unit 51 accordingly remains arranged beneath the table 7. 53 denotes a first transmission pulley, which is integral for rotation with the shaft 52 at the end 52a thereof. A corresponding second pulley 54 is keyed onto the output shaft 55 of a motor 56 belonging to the motor unit 51 provided for actuation of the centering elements 11. A continuous annular transmission belt 57 is provided between the pulleys 53 and 54. It is understood that kinematic transmission means equivalent to said belt transmission may alternatively be provided between the motor 56 and the shaft 52.

A clamping oil distributor is denoted 58 and shown only schematically, said distributor being provided at the end 52 of the shaft, the lines from which are connected with the axial cavity of the shaft and through which the oil is conveyed upwards into the zone of the table 7 for the clamping function.

In operation, after rotation of the motor 56 and consequently of the shaft 52 and, integral therewith, of the toothed wheel 19, corresponding and synchronized rotational movements are transmitted to the manoeuvring rods 15 and, thanks to the mating between the pinions 18 and wheel 19, a synchronous translational movement of the three centering elements 11 is effected, these elements operating in entirely similar manner to that described in relation to the preceding example.

In relation to this second exemplary embodiment of the invention, in addition to the advantages already outlined in relation to the preceding Example, it should be emphasised how the placement of the motor unit provides the advantage of limiting the transverse dimensions of the device, in particular in the outer radial zones corresponding to the centering elements.

Another advantage consists in the fact that there is a reduction in the rotating masses on the worktable (by providing the motor below the table and not integral for rotation therewith), with a consequent reduction in inertial effects due to the centrifugal forces generated on rotation of the table.

Although the illustrative embodiments of the present invention have been described in detail with reference to the accompanying drawings, it is to be understood that the invention is not limited to this precise embodiments and that various changes or modifications may be effected therein by one skilled in the art without departing from the scope or spirit of the invention.

1. A device for clamping in centered position parts to be subjected to machining, comprising:
a part centering device including at least three centering elements with a regular angular spacing which are capable of contacting the part and displacing it to a centered position, each of the centering elements being displaceable along a predetermined radial direction (Y), said radial directions (Y) intersecting at a geometric part centering axis (X),
actuating means associated with each respective centering element for operational actuation thereof in the translational movement along the corresponding radial direction (Y), said actuating means comprise:
for each centering element, a respective actuating element capable of being driven in a rotational motion and respective first motion transmission means capable of converting the rotational motion of the actuating element into a translational motion of the corresponding centering element along the corresponding radial direction (Y), and
second motion transmission means, between said actuating elements, capable of synchronously transmitting the rotational motion from one of said actuating elements to the other actuating elements, so as to permit synchronized translational movement of the centering elements along the respective radial translation directions (Y).

2. The device according to claim 1, comprising guide means associated with each respective centering element to guide the movement thereof along the respective radial direction (Y) between a first non-operating position close to the geometric centering axis (X) and a second operating position, remote from the geometric axis, in which the centering element interacts with the part until the part is centered relative to the axis (X).

3. The device according to claim 1, in which said motion transmission means comprise, for each centering element, mating of the screw/internal thread type between the centering element and the respective actuating element.

4. The device according to claim 3, in which said actuating element comprises a maneuvering rod comprising externally a thread constituting said screw.

5. The device according to claim 4, in which said screw is of the recirculating ball type.

6. The device according to claim 5, in which said internal thread is located in a lead nut structure integral with the corresponding centering element.

7. The device according to claim 4, in which said second transmission means comprise, for each centering element, a respective first gear integral for rotation with the corresponding maneuvering rod, said first gears all meshing with a common second gear, such that the rotational motion of one of said maneuvering rods is synchronously transferred to all other maneuvering rods.

8. The device according to claim 7, in which said second gear and each of said first gears constitutes a pair of gears with orthogonal axes respectively taking the form of a bevel wheel and pinion.

9. The device according to claim 8, in which said bevel wheel is coaxial with the geometric centering axis (X) of the device.

10. The device according to claim 4, comprising motor means associated with at least one of said maneuvering rods to drive the corresponding screw in rotation.

11. The device according to claim 7, comprising motor means operationally associated with said common second gear, such that the rotational motion of said second gear is synchronously transferred to each respective maneuvering rod of the device.

12. The device according to claim 11, comprising a transmission shaft kinematically connected to said motor means and with which said second gear is integral for rotation, said shaft extending coaxially with the geometric axis (X) of the device.

13. The device according to claim 12, in which said transmission shaft is of hollow tubular construction.

14. The device according to claim 12, in which between said motor means and said transmission shaft there is provided a belt transmission approximate to the end of the shaft axially opposite the end of the shaft connected to said common second gears.

15. The device according to claim 1, comprising, on each centering element, first clamping means for selectively clamping the part relative to the corresponding centering element once a preselected centering position is reached.

16. The device according to claim 15, comprising, for each centering element, second clamping means for selectively clamping the corresponding centering element relative to a worktable in the preselected position along the radial translation direction (Y) of the centering element.

17. A machine tool for machining parts, comprising a device for clamping parts in a centered position to be subjected to machining according to claim 1.

18. A machine tool for machining parts, comprising a device for clamping parts in a centered position to be subjected to machining according to claim 2.

19. A machine tool for machining parts, comprising a device for clamping parts in a centered position to be subjected to machining according to claim 3.

20. A machine tool for machining parts, comprising a device for clamping parts in a centered position to be subjected to machining according to claim 4.
